(19) United States
(12) Patent Application Publication
(10) Pub. No.: US 2013/0026809 A1
(43) Pub. Date: Jan. 31, 2013

(54) SEAT ADJUSTER

(71) Applicants: Andrew Pierson, Buehl (DE); Andreas Stock, Karlsruhe (DE); Jens Schrader, Baden-Baden (DE); Gilles Peter, Morsbronn Les Bains (FR)

(72) Inventors: Andrew Pierson, Buehl (DE); Andreas Stock, Karlsruhe (DE); Jens Schrader, Baden-Baden (DE); Gilles Peter, Morsbronn Les Bains (FR)

(73) Assignee: ROBERT BOSCH GMBH, Stuttgart (DE)

(21) Appl. No.: 13/575,980

(22) PCT Filed: Jan. 24, 2011
(86) PCT No.: PCT/EP11/50893

§ 371 Date: Oct. 12, 2012

(30) Foreign Application Priority Data
Jan. 29, 2010 (DE) 10 2010 001 352.8

(51) Int. Cl. B60N 2/44; A47C 7/02

(52) U.S. Cl. 297/463.1

(57) ABSTRACT

The invention relates to a seat adjuster (100) especially for a seat (105) in a motor vehicle, comprising an adjusting element (115), an electric adjusting device (110) and a transmission device (120) for transmitting adjusting forces between the electric adjusting device and the adjusting element, the transmission device comprising a transmission element (320) for transmitting adjusting forces and the transmission element being flexible at a right angle to the direction of the adjusting forces.

### BACKGROUND OF THE INVENTION

An adjustable seat for an occupant of a motor vehicle may be manually operated or motor-operated. Aside from the usual adjustment functions for seat inclination and sliding the seat along the direction of travel, it is additionally possible for example for a headrest, an armrest, a lumbar support, a seat height or seat inclination position or other movable elements of the seat to be adjusted. Furthermore, such a seat may comprise seat elements which, if the motor vehicle is involved in a severe accident, are moved automatically and if appropriate in an accelerated manner into a position in which they serve to provide improved support of the occupant of the motor vehicle.

Drives for actuating the adjustable elements of the seat may be of electrical construction, of pneumatic construction, of pyrotechnic construction or of a construction based on a preloaded spring. As the number of adjustable seat elements and drives for the seat elements increases, the weight, complexity and manufacturing costs of the seat also increase.

EP 1 726 475 A1 presents a device for the motor-powered actuation of a side cheek of a seat of a motor vehicle as a function of a signal which indicates the risk of an accident of the motor vehicle.

EP 1 633 606 B1 (WO 2004/103779 A1) provides an occupant protection system for motor vehicles, wherein at least one actuator with two speed stages acts on a seat adjuster. A first, slow speed stage provides comfort adjustment facility of the seat, whereas a second, fast speed stage is used for a rapid adjustment in the event of an impending accident. Actuators which are used may comprise electric motors, a pneumatic system or preloaded mechanical springs.

### SUMMARY OF THE INVENTION

It is an object of the invention to specify an improved seat adjuster for a seat in a motor vehicle.

According to the invention, a seat adjuster, in particular for a seat in a motor vehicle, comprises an adjusting element, a linear electrical adjusting device and a transmission device for transmitting adjustment forces between the electrical adjusting device and the adjusting element, wherein the transmission device has a transmission element for transmitting adjustment forces, said transmission element being flexible transversely with respect to the direction of the adjustment forces.

The adjustment element may for example change a position of the seat in the motor vehicle or adjust a restraint element for supporting a person in the seat. As a result of the transmission of adjustment forces by means of a flexible and in particular bendable transmission element, a position of the electrical adjusting device can be selected independently of the position of the adjusting element. This provides an additional degree of design freedom in the configuration and mounting of the electrical adjusting device and of the adjusting element. Furthermore, a mass distribution of the seat adjuster or of the seat may be optimized, for example with regard to a minimized risk of injury in the event of an accident. Furthermore, the electrical adjusting device may be mounted so as to be easily accessible for assembly and maintenance work. It is also possible, through the provision of a flexible transmission device, for the adjusting element and the electrical adjusting device to be mounted on separate elements of the seat which can be adjusted in terms of their position relative to one another, for example by means of a further adjusting device.

The electrical adjusting device preferably comprises a rotatable drive element which engages with a rising spiral. In this way, the linear adjustment may be provided by means of an electric motor. Furthermore, the rising spiral may be designed so as to form, together with the rotatable drive element, an overload clutch which slips if a predefined adjustment force is exceeded, thus minimizing damage to the seat adjuster and/or injury to a vehicle occupant in the region of the seat. Furthermore, an alignment of the adjusting element can be realized by rotation of the rising spiral relative to the drive element. A play-free articulated connection of the adjusting element can thus be attained.

To the transmission element there may also be connected a further rising spiral which engages with a threaded element of the adjusting element. The two rising spirals may be arranged on opposite ends of the adjusting element and may be coiled in the same direction or in opposite directions. If both rising spirals are coiled in the same direction, then during the course of an alignment, a position of the transmission element relative to the adjusting element and relative to the adjusting element can be adjusted. If the two rising spirals are coiled in opposite directions, the positions of the adjusting element and of the electrical adjusting device relative to one another can be varied by rotation of the adjusting element.

The further rising spiral in the region of the adjusting element may be connected to a transmission element, wherein in all operating positions of the seat adjuster, the transmission element is arranged in the region of an axial end of a sheath of the transmission element. In this way, during the actuation of the seat adjuster, no portion of the rising spiral passes the axial end of the sheath, as a result of which rattling or clattering noises can be prevented. The transmission element may be of generally cylindrical form and in particular of generally straight cylindrical form, such that no channels or steps which run transversely with respect to the actuating device pass the axial end of the sheath. It is possible for the transmission element to be formed, correspondingly to the sheath, with a non-circular cross section, for example an elliptical or polygonal cross section, such that twist prevention can also be realized in addition to noise reduction.

The seat adjuster may comprise two cable pull portions which are actuated in antiparallel fashion by the electrical adjusting element. Through the use of cable pull portions, it is possible for adjustment forces to be transmitted between the adjusting device and the adjusting element along radii so small that a transmission by means of a Bowden cable would generate disadvantageously high friction forces. If appropriate, a diverting roller may be provided for guidance and diversion of one of the cable pull portions. An embodiment of the seat adjuster with cable pull portions may have an advantageously reduced mass.

In one embodiment, the two cable pull portions are part of a single-piece cable pull. In this way, it can be made easier for the cable pull portions to be mounted and exchanged. A non-positive connection in the region of the adjusting element may be realized by means of clamping, as a result of which the adjusting element can be aligned relative to the cable pull portions.

It is possible for at least one further adjusting element and one further transmission device for transmitting adjustment forces between the electrical adjusting device and the further adjusting element to be provided. In this way, it is possible for multiple adjusting elements to be actuated by means of the same adjusting device, as a result of which a complexity of the seat adjustment can be minimized and production costs can be saved. The two adjusting elements may be actuated in opposite directions by the electrical adjusting device. In this way, it is advantageously possible for symmetrical adjusting elements of the seat to be actuated in opposite directions by a single adjusting device.

A sensor for determining an adjustment position may be arranged in the region of an end surface of one of the rising spirals. For example, it is possible in this way for a limit switch of the adjusting device to be of functionally reliable and space-saving form and if appropriate integrated with the adjusting device or the adjusting element.

### BRIEF DESCRIPTION OF THE DRAWINGS

The invention will now be explained in more detail with reference to the appended figures, in which:

FIG. 1 shows a seat adjuster on a seat in a motor vehicle;

FIG. 2 shows the electrical adjusting device of the seat adjuster from FIG. 1;

FIG. 3 shows a longitudinal section through the seat adjuster from FIG. 1; and

FIG. 4 shows a schematic illustration of a variant of the seat adjuster of FIGS. 1 and 3.

### DETAILED DESCRIPTION

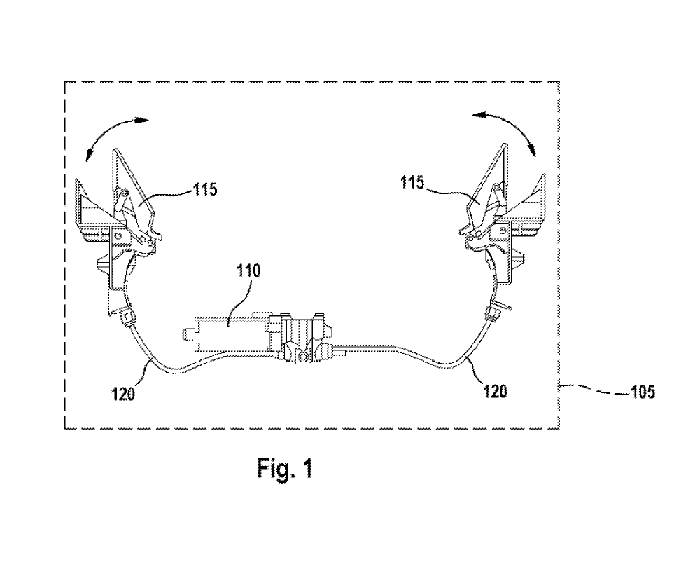

FIG. 1 shows a seat adjuster 100 in a seat 105 in a motor vehicle. An electric adjusting device 110 is arranged between two adjusting elements 115 of mirror-symmetrical construction. Two transmission devices 120 transmit adjusting forces between the electrical adjusting device 110 and the two adjusting elements 115. The illustrated adjusting elements are for example side supports which are arranged on the right and on the left in the region of a backrest of the seat. If the two adjusting elements 115 are deployed, that is to say folded inward in the illustration, they provide additional side support to the left and to the right for a vehicle occupant sitting on the seat. The deployment may be realized for example for reasons of comfort, owing to expected high cornering speeds as a result of sporty driving, or during the course of preparation for an expected collision of the motor vehicle against an obstruction. An adjustment speed of the electrical adjusting device 110 may be realized in user-controlled form or automatically in different speed stages.

The adjusting elements 115 are cushioned and covered by a lining of the seat, such that the adjusting elements 115 in the seat are not readily visible. The electric adjusting device 110 may be fastened to the seat 105 or, in another embodiment, may be connected to the motor vehicle. In one embodiment, the electrical adjusting device 110 is situated in the region of a seat surface of the seat, such that the transmission devices 120 transmit adjustment forces between the electrical adjusting device 110 and the adjusting elements 115 in the case of different angles having been set between the backrest and the seat surface.

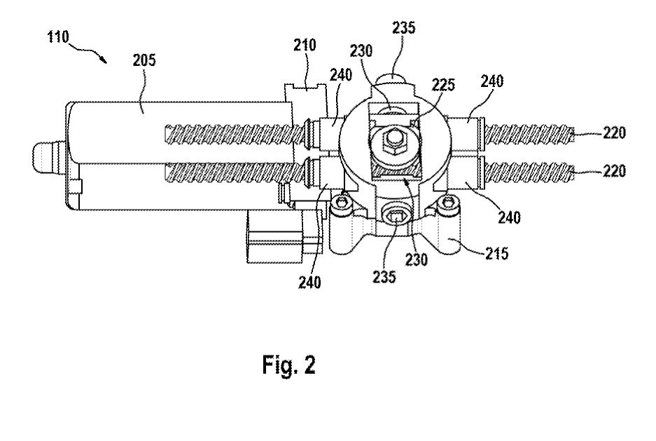

FIG. 2 shows the adjusting device 110 of the seat adjuster 100 from FIG. 1. An electric motor 205 is flange-mounted axially on a gearbox 210. The gearbox 210 may be for example a spur gear mechanism or a planetary gear set. The gearbox 210 is connected to a drive output housing 215 through which two parallel-running rising spirals 220 extend. Between the rising spirals 220 there is situated a drive output gearwheel 225 which engages into both rising spirals 220. Within the drive output housing 215 there is situated an angular gear, which is not visible in the illustration of FIG. 2, for converting a rotational movement provided by the gearbox 210 into a rotational movement, running perpendicular thereto, of the drive output gearwheel 225. The two rising spirals 220, in the region of engagement with the drive output gearwheel 225, are pressed in the radial direction against the drive output gearwheel 225 by means of a respectively associated spring 230. Each spring 230 is assigned an adjustment screw 235 which runs through the drive output housing 215, wherein the two adjusting screws 235 are situated opposite one another with respect to the drive output gearwheel 225. Through rotation of the adjusting screws 235, a pressing force of the associated rising spiral 220 against the drive output gearwheel can be adjusted.

If the electric motor 205 is electrically activated, it moves the drive output gearwheel 225 via the gearbox 210, and moves the rising spirals 220 in opposite directions to the left and to the right. In the process, thread flights on the rising spirals 220 protrude individually into tooth spaces between teeth of the drive output gearwheel 225 and ensure a reliable non-positive connection. The conversion of the rotational movement of the gearwheel 225 into linear movements of the rising spirals 220 exhibits self-locking, that is to say a force acting axially on a rising spiral 220 cannot set the drive gearwheel 225 in rotation.

However, if the axial force acting on the rising spiral 220 exceeds a force predetermined by the spring 230 in conjunction with the adjusting screw 235 assigned thereto, the rising spiral 220 is lifted from the drive output gearwheel 225 in the radial direction, such that the engagement between the rising spiral 220 and the drive output gearwheel 225 is eliminated and the rising spiral 220 can be moved in the axial direction. If the axial movement falls below a force predetermined by the spring 230 in conjunction with the adjusting screw 235 assigned thereto, the rising spiral 220 engages into the drive output gearwheel 225 in the radial direction again such that the axial movement of the rising spiral 220 is blocked. To permit the displacement movement of the rising spiral 220 in the radial direction, the rising spiral 220 may be produced from an elastic material, for example plastic. Furthermore, the rising spirals may have rounded spiral flanks. If necessary, different forces beyond which the engagement of the respective rising spiral 220 with the drive output gearwheel 225 is released may be set by means of the two adjusting screws 235 for the two rising spirals 220.

The drive output housing 215 comprises four threaded sleeves 240 through which the rising spirals 220 run at their points of entry and exit into and out of the drive output housing 215. The threaded sleeves 240 are provided for the fastening of sheaths of Bowden cables which transmit the movement of the rising spirals 220.

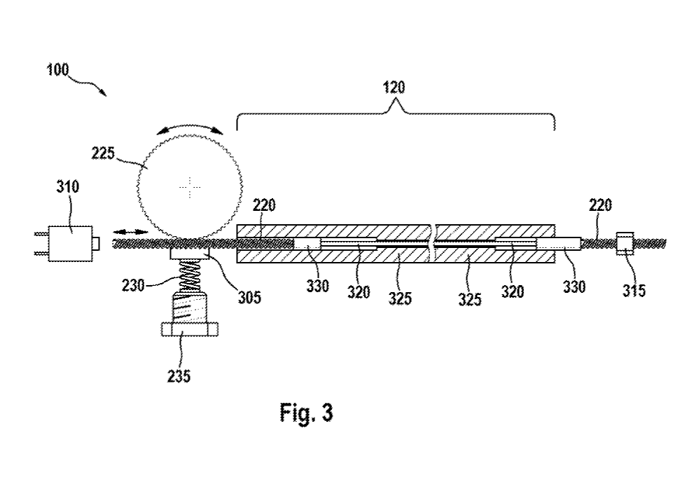

FIG. 3 shows a longitudinal section through the seat adjuster 100 from FIG. 1, wherein in order to provide a clearer illustration, only selected elements are shown. As explained above with reference to FIG. 2, the left-hand rising spiral 220 is pressed in the radial direction against the drive output gearwheel 225 by means of the spring 230 and the adjusting screw 23. In the illustrated embodiment, for the guidance of the left-hand rising spiral 220, a sliding block 305 is arranged between the spring 230 and the left-hand rising spiral 220. The teeth of the drive output gearwheel 225 engage with thread flights of the left-hand rising spiral 220, such that a rotational movement of the drive output gearwheel 225 is converted into a linear movement of the left-hand rising spiral 220. In the region of a left-hand axial end surface of the left-hand rising spiral 220 there is arranged a limit switch 310 by means of which it is detected when the left-hand rising spiral 220 has reached a left-hand end position.

The transmission device 120 transmits the linear movement of the left-hand rising spiral 220 to a right-hand rising spiral 220. The right-hand rising spiral 220 engages with an adjusting nut 315 which transmits an axial movement of the right-hand rising spiral 220 to the adjusting element 115 from FIG. 1.

The transmission device 120 comprises a transmission element 320 and a sheath 325, of which substantially only end portions are shown in FIG. 3. The transmission element 320 may be for example a wire cable by means of which torsional, tensile and thrust forces can be transmitted between the left-hand and right-hand rising spirals 220. The sheath 325, like the transmission element 320, is flexible transversely with respect to a direction of transmission of adjustment forces, for example upward and downward in the illustration of FIG. 3, but cannot be compressed or stretched significantly in the axial direction. The transmission device 120 may therefore be laid along a curved path without the transmission of adjustment forces being significantly impaired by the bending. A minimum bend radius is dependent here primarily on materials of the transmission element 320 and of the sheath 325 and on the inner and outer diameters thereof.

At its left-hand axial end, the sheath 325 is connected to one of the threaded sleeves from FIG. 2. It is ensured in this way that, in said region, the left-hand rising spiral 220 and the sheath 325 run coaxially with respect to one another so as to maintain a radial minimum spacing with respect to one another, such that no clattering or rattling noises are generated during an axial movement of the rising spiral 220 into and out of the sheath 325. A left-hand thrust rod 330 connects the rising spiral 220 to the transmission element 320, wherein the left-hand thrust rod 330 always runs within the sheath 325.

A corresponding threaded sleeve 240 may be provided at a right-hand axial end of the sheath 325. In the embodiment illustrated in FIG. 3, to prevent rattling or clattering noises in the region of the right-hand end of the sheath 325, a right-hand thrust rod 330 is arranged between the transmission element 320 and the rising spiral 220. The right-hand thrust rod 330 is of such a length that, between a left-hand and a right-hand end position of the rising spiral 220, the right-hand rising spiral 220 does not protrude or slide out into the right-hand axial end of the sheath 325.

The left-hand and the right-hand rising spirals 220 are coiled in opposite directions. Since the transmission element 320 also transmits torsional forces, an assembly composed of the left-hand rising spiral, the left-hand thrust rod 330, the transmission element 320, the right-hand thrust rod 330 and the right-hand rising spiral 220 can be rotated conjointly. Here, depending on the direction of rotation, a spacing of the drive output gearwheel 225 from the adjusting nut 315 along the transmission device 120 is increased or decreased. As a result, a position of the adjusting element 115 can be adjusted independently of a rotation of the drive output gearwheel 225. Furthermore, in the case of a mirror-symmetrical articulated connection of two adjusting elements 115 as shown in FIGS. 1 and 2, a relative position of the adjusting elements 115 can be varied by means of the described rotation.

In an alternative embodiment which is not shown, the left-hand rising spiral 120 and the right-hand rising spiral 220 are, in FIG. 3, coiled in the same directions. In this case, the described rotation does not result in a change of the relative position of the adjusting element 115 relative to the drive output gearwheel 225; instead, the assembly composed of the left-hand rising spiral 120, the left-hand thrust rod 330; the transmission element 320, the right-hand thrust rod 330 and the right-hand rising spiral 220 can be moved to the left or the right, depending on the direction of rotation. In this way, it is for example possible for a triggering position of the limit switch 310 to be reached.

During operation of the seat adjuster 100, the described rotation may be prevented for example through the provision of a lock nut on the adjusting nut 315 on the right-hand rising spiral 220. If a transmission of torsional forces between the left-hand and right-hand rising spirals 220 is undesired, then a swivel element (not illustrated) may be arranged between one of the two rising spirals 220 and the associated thrust rod 330. Each of the rising spirals 220 may then be rotated independently of the other rising spiral 220, such that on the whole, both a position of the rising spiral 220 relative to the limit switch 310 and also an alignment of the adjusting element 115 relative to a position of the drive output gearwheel 225 can be adjusted, as discussed above.

In a further embodiment, in the region of the adjusting nut 315, an arrangement is used which corresponds to the arrangement composed of the drive output gearwheel 225, the sliding block 305, the spring 230 and the adjusting screw 235. The linear movement of the right-hand rising spiral 220 is thereby converted into a rotational movement, wherein an integrated overload protection means for preventing excessive thrust forces is implemented, as discussed above. The overload protection means in the region of the electrical adjusting device 110 may also be omitted.

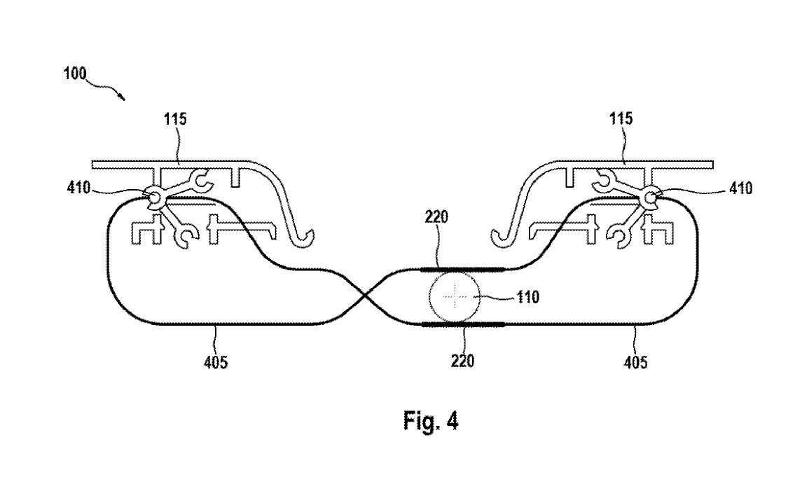

FIG. 4 is a schematic illustration of a variant of the seat adjuster 100 of FIGS. 1 and 3. The electrical adjusting device 110 is arranged between the two adjusting elements 115 from FIG. 1. The two rising spirals 220 are actuated linearly in antiparallel fashion by the electric adjusting device from FIGS. 1 and 2. Portions of a cable pull 405 run in each case between the rising spirals 220 and the adjusting elements 115. In the region of each adjusting element 115, the ends of the portions of the cable pull 405 are connected to one another at a knee lever joint 410, or are formed in one piece with one another and fastened to the knee lever joint 410. Such an arrangement is conventional for window lifters or sliding roofs of motor vehicles.

Those portions of the cable pull 405 which are connected to the left-hand adjusting element 115 are connected to the rising spirals 220 in an interchanged manner with respect to those portions of the cable pull 405 which are connected to the right-hand adjusting element 115, such that in a first direction of actuation of the electrical adjusting device 110, the two knee lever joints 410 are moved inward and the two adjusting elements 115 are spread out, and in a second direction of actuation of the electric adjusting device 110, the two knee lever joints 410 are moved outward and the two adjusting elements 115 are folded in.

The transmission of the linear movement of the rising spirals 220 of the electrical adjusting device 110 by means of the portions of the cable pull 405 to the knee lever joints 410 of the adjusting elements 115 may be guided, analogously to the above description with regard to FIG. 3, by means of a Bowden cable or, for example with the omission of a sheath 325 of the portions of the cable pull 405, by means of cable rollers (not illustrated). In a further embodiment of the device 100 as per FIG. 4, the rising spirals 220 may be omitted; a facility for adjustment of the knee lever joint 410 without actuation of the adjusting device 110, as described above with regard to FIG. 3, is then not provided.

1. A seat adjuster (100), comprising:
an adjusting element (115);
a linear electrical adjusting device (110); and
a transmission device (120) for transmitting adjustment forces between the electrical adjusting device (110) and the adjusting element (115),
characterized in that
the transmission device (120) has a transmission element (320) for transmitting adjustment forces, wherein the transmission element (320) is flexible transversely with respect to the direction of the adjustment forces.

2. The seat adjuster (100) as claimed in claim 2, characterized in that the electrical adjusting device (110) comprises a rotatable drive element (225) which engages with a rising spiral (220).

3. The seat adjuster (100) as claimed in claim 1, characterized by a further rising spiral (220) which is connected to the transmission element (320) and which engages with a threaded element (315) of the adjusting element (115).

4. The seat adjuster (100) as claimed in claim 3, characterized in that the rising spiral (220) and the further rising spiral (220) are coiled in opposite directions.

5. The seat adjuster (100) as claimed in claim 3, characterized in that, in a region of the adjusting element (115), the further rising spiral (220) is connected to a transmission element (330), wherein in all operating positions of the seat adjuster (100), the transmission element (330) is arranged in a region of an axial end of a sheath (325) of the transmission element (320).

6. The seat adjuster as claimed in claim 5, characterized in that the transmission element (330) has a generally cylindrical form.

7. The seat adjuster (100) as claimed in claim 1, characterized in that the transmission device (120) comprises two cable pull portions (405) which are actuated in antiparallel fashion by the electrical adjusting element (115).

8. The seat adjuster (100) as claimed in claim 7, characterized in that the two cable pull portions (405) are parts of a single-piece, continuous cable pull (405).

9. The seat adjuster (100) as claimed in claim 1, characterized by at least one further adjusting element (115) and a further transmission device (120) for transmitting adjustment forces between the electrical adjusting device (110) and the further adjusting element (115).

10. The seat adjuster (100) as claimed in claim 9, characterized in that the adjusting element (115) and the further adjusting element (115) are actuated in opposite directions by the electrical adjusting device (110).

11. The seat adjuster (100) as claimed in claim 2, wherein the rotatable device element is a drive output gearwheel, characterized in that the rising spiral (220), in a region of engagement with the drive output gearwheel (225), is pressed in a radial direction against the drive output gearwheel (225) with an associated adjustable spring force, as a result of which the rising spiral (220) is arranged such that the rising spiral can be swung out of toothing of the drive output gearwheel (225) as an overload protection means for preventing excessive thrust forces.

12. The seat adjuster (100) as claimed in claim 3, characterized in that a sensor (310) for determining an adjustment position is arranged in a region of an end surface of one of the rising spirals (220).

13. The seat adjuster (100) as claimed in claim 4, characterized in that, in a region of the adjusting element (115), the further rising spiral (220) is connected to a transmission element (330), wherein in all operating positions of the seat adjuster (100), the transmission element (330) is arranged in a region of an axial end of a sheath (325) of the transmission element (320).

14. The seat adjuster as claimed in claim 13, characterized in that the transmission element (330) has a generally cylindrical form.

15. The seat adjuster (100) as claimed in claim 14, characterized in that the transmission device (120) comprises two cable pull portions (405) which are actuated in antiparallel fashion by the electrical adjusting element (115).

16. The seat adjuster (100) as claimed in claim 15, characterized in that the two cable pull portions (405) are parts of a single-piece, continuous cable pull (405).

17. The seat adjuster (100) as claimed in claim 16, characterized by at least one further adjusting element (115) and a further transmission device (120) for transmitting adjustment forces between the electrical adjusting device (110) and the further adjusting element (115).

18. The seat adjuster (100) as claimed in claim 17, characterized in that the adjusting element (115) and the further adjusting element (115) are actuated in opposite directions by the electrical adjusting device (110).

19. The seat adjuster (100) as claimed in claim 18, wherein the rotatable device element is a drive output gearwheel, characterized in that the rising spiral (220), in a region of engagement with the drive output gearwheel (225), is pressed in a radial direction against the drive output gearwheel (225) with an associated adjustable spring force, as a result of which the rising spiral (220) is arranged such that the rising spiral can be swung out of toothing of the drive output gearwheel (225) as an overload protection means for preventing excessive thrust forces.

20. The seat adjuster (100) as claimed in claim 19, characterized in that a sensor (310) for determining an adjustment position is arranged in a region of an end surface of one of the rising spirals (220).
